(19) United States
(12) Patent Application Publication
(10) Pub. No.: US 2019/0269181 A1
(43) Pub. Date: Sep. 5, 2019

(54) AIRBAG INCLUDING VENT HOLE

(71) Applicant: BNR CO., LTD., Incheon (KR)

(72) Inventors: Gyeongcheol BAE, Seoul (KR); Sungki MIN, Seoul (KR); Gichang KIM, Seoul (KR); Bonggwan JEON, Gyeonggi-do (KR); Junghwa HONG, Seoul (KR)

(73) Assignee: BNR CO., LTD., Incheon (KR)

(21) Appl. No.: 16/332,197

(22) PCT Filed: May 18, 2017
(86) PCT No.: PCT/KR2017/005167

§ 371 Date: Mar. 11, 2019

(30) Foreign Application Priority Data
Sep. 12, 2016 (KR) 10-2016-0117405

(51) Int. Cl. A41D 13/018; A41D 31/28; A41D 13/05; F17C 7/00

(52) U.S. Cl. CPC A41D 13/018; A41D 31/28; F17C 2270/0772; F17C 7/00; A41D 13/0506

(57) ABSTRACT

The present disclosure relates to an airbag including a vent hole. The airbag including a vent hole, according to the present disclosure, comprises: a protection means (100) mounted on a predetermined part of a user, and inflated when gas is injected therein, thereby protecting the user; a body part (200) inserted into the vent hole (150), which is formed in the protection means (100), so as to enable fluid to flow through the inner and outer sides of the protection means (100); an elastic body (300) closing the body part (200), and inflated by the pressure of the gas inside the protection means (100) when the gas is injected into the protection means (100); and an opening and closing means (400), which opens the body part (200) by tearing the inflated elastic body (300) after the user falls, so as to discharge, to the outside, the gas injected into the protection means (100).

### TECHNICAL FIELD

The present disclosure relates to an airbag including a vent hole.

### BACKGROUND ART

In modern society, older population is growing fast with aging, and accordingly, safety related accidents of old people are raised as an important social issue. Among safety related accidents, falls in old people often occur, and are one of the leading causes of death among old people. Due to falls, pelvis and hip joint fractures occur most frequently, and old people are so physically weak for an operation, and even though the operation was successfully conducted, they have difficulties in recovery. Furthermore, when falls occur, secondary injuries caused by shocks to human body may lead to head, neck and spine injuries. Accordingly, there is a demand for a protection system capable of absorbing impact energy to prevent injuries caused by falls.

To protect human body from falls, various technologies such as hip protectors and wearable airbags have been developed. However, users tend to be reluctant to wear hip protectors due to the inconvenience in wearing. Accordingly, hip protectors have a limitation in showing the expected protection performance. Meanwhile, wearable airbags hips are expected to provide good protection performance on primary injuries of hips caused by falls. However, the conventional wearable airbags have a problem with secondary injuries of other body parts that may be caused by the rebound force of the airbags produced due to shocks.

### RELATED LITERATURES

### Patent Literatures

(Patent Literature 1) KR10-1093780 B1

### DISCLOSURE

### Technical Problem

The present disclosure is designed to solve the problem of the related art as described above, and an aspect of the present disclosure relates to an airbag including a vent hole, in which the vent hole for discharging gas injected into protection means to the outside is controlled to prevent secondary injuries of other body parts caused by the rebound force of the protection means.

### Technical Solution

An airbag including a vent hole according to an embodiment of the present disclosure includes a protection means which is mounted on a predetermined body part of a user, and expands to protect the user when gas is injected, a body portion which is inserted into a vent hole formed in the protection means to bring inside and outside of the protection means into fluid communication, an elastic body which closes the body portion, and expands by internal gas pressure of the protection means when the gas is injected into the protection means, and an opening/closing means which after the user falls, tears the expanded elastic body to open the body portion so as to discharge the gas injected into the protection means to outside.

Additionally, in the airbag including a vent hole according to an embodiment of the present disclosure, the body portion extends in a tubular shape, the elastic body is provided within one end of the body portion, and expands toward the other end of the body portion by the internal gas pressure of the protection means when the gas is injected into the protection means, and the airbag including a vent hole further includes a confining means which is provided at the other end of the body portion to confine the expansion of the elastic body while discharging the gas injected into the protection means.

Additionally, in the airbag including a vent hole according to an embodiment of the present disclosure, the opening/closing means tears the elastic body between one end and the other end of the body portion.

Additionally, in the airbag including a vent hole according to an embodiment of the present disclosure, the body portion includes a body formed in a tubular shape, and a flat plate portion which extends in a radial direction from one end of the body and contacts an inner side of the protection means.

Additionally, in the airbag including a vent hole according to an embodiment of the present disclosure, the elastic body is provided within one end of the body, and expands toward the other end of the body by the internal gas pressure of the protection means when the gas is injected into the protection means, and the airbag including a vent hole further includes a confining means which is provided at the other end of the body to confine the expansion of the elastic body while discharging the gas injected into the protection means.

Additionally, in the airbag including a vent hole according to an embodiment of the present disclosure, the body portion further includes a support protrusion which protrudes out from one end of the body, and contacts one surface of the elastic body.

Additionally, the airbag including a vent hole according to an embodiment of the present disclosure further includes a fixing body which is formed in a tubular shape, and is inserted into the body such that one end contacts the other surface of the elastic body.

Additionally, in the airbag including a vent hole according to an embodiment of the present disclosure, a guide protrusion extending in a lengthwise direction of the fixing body is formed on an outer peripheral surface of the fixing body, and a guide groove extending in a lengthwise direction of the body is formed on an inner peripheral surface of the body such that the guide groove matches the guide protrusion.

Additionally, in the airbag including a vent hole according to an embodiment of the present disclosure, the other end of the fixing body is configured to be contacted with a cover and fixed thereto, the cover being coupled to the body.

Additionally, in the airbag including a vent hole according to an embodiment of the present disclosure, the confining means is placed between the fixing body and the cover.

Additionally, in the airbag including a vent hole according to an embodiment of the present disclosure, a first screw thread is formed on an outer peripheral surface of the body, a second screw thread is formed on an inner peripheral surface of the cover, and the first screw thread and the second screw thread are screw-coupled together.

Additionally, in the airbag including a vent hole according to an embodiment of the present disclosure, the confining means is a mesh net.

Additionally, in the airbag including a vent hole according to an embodiment of the present disclosure, the opening/closing means includes a needle portion having a sharp tip, and a movement means which moves the needle portion toward the expanded elastic body.

Additionally, in the airbag including a vent hole according to an embodiment of the present disclosure, the movement means is a solenoid actuator.

Additionally, the airbag including a vent hole according to an embodiment of the present disclosure further includes a support, and the support includes a support housing which supports the opening/closing means, and a support plate which extends from the support housing, has, at a center thereof, an insertion hole into which the body is inserted, and contacts an outer side of the protection means, facing the flat plate portion.

Additionally, in the airbag including a vent hole according to an embodiment of the present disclosure, the flat plate portion has a coupling protrusion which protrudes toward the support plate, the support plate has a coupling hole which matches the coupling protrusion, and the coupling protrusion is inserted into the coupling hole.

Additionally, in the airbag including a vent hole according to an embodiment of the present disclosure, the support plate is fixed in contact with a coupling means coupled to the body.

Additionally, in the airbag including a vent hole according to an embodiment of the present disclosure, a first screw thread is formed on an outer peripheral surface of the body, a third screw thread is formed on an inner peripheral surface of the coupling means, and the first screw thread and the third screw thread are screw-coupled together.

These and other features and advantages of the present disclosure will be apparent from the following detailed description based on the accompanying drawings.

Prior to the description, the terms or words used in the specification and the appended claims should not be construed as limited to general and dictionary meanings, but interpreted based on the meanings and concepts corresponding to the technical spirit of the present disclosure on the basis of the principle that the inventor is allowed to define the terms appropriately for the best explanation.

### Advantageous Effects

According to the present disclosure, it is possible to prevent secondary injuries of other body parts caused by the rebound force of the protection means by controlling the vent hole to discharge gas injected into the protection means to the outside.

Furthermore, according to the present disclosure, it is possible to discharge gas injected into the protection means to the outside at an accurate time by tearing the elastic body with the opening/closing means.

Moreover, according to the present disclosure, it is possible to reuse the airbag including a vent hole by simply replacing the elastic body after gas injected into the protection means is discharged to the outside.

### DESCRIPTION OF DRAWINGS

FIG. 1 is a conceptual diagram of an airbag including a vent hole according to an embodiment of the present disclosure.

FIG. 2 is an operational conceptual diagram of an airbag including a vent hole according to an embodiment of the present disclosure.

FIG. 3 is a perspective view of an airbag including a vent hole according to an embodiment of the present disclosure.

FIG. 4 is a cut-away perspective view of the airbag including a vent hole shown in FIG. 3, taken along the line A-A.

FIG. 5 is a cut-away perspective view of the airbag including a vent hole shown in FIG. 3, taken along the line B-B.

FIG. 6 is an exploded perspective view of the airbag including a vent hole shown in FIG. 3.

FIGS. 7 to 10 are cross-sectional views showing the operation process of an airbag including a vent hole according to an embodiment of the present disclosure.

### BEST MODE

These and other objects, advantages and features of the present disclosure will be apparent from the following detailed description and exemplary embodiments associated with the accompanying drawings. In adding the reference numerals to the elements of each drawing in the specification, it should be noted that identical elements have identical reference numerals as possible even though they are indicated on different drawings. Furthermore, the terms “first”, “second”, etc. are used to distinguish one element from another, and the elements are not limited by the terms. Hereinafter, in describing the present disclosure, a detailed description of known relevant that may render the key subject matter of the present disclosure unnecessarily ambiguous is omitted herein.

Hereinafter, exemplary embodiments of the present disclosure will be described in detail with reference to the accompanying drawings.

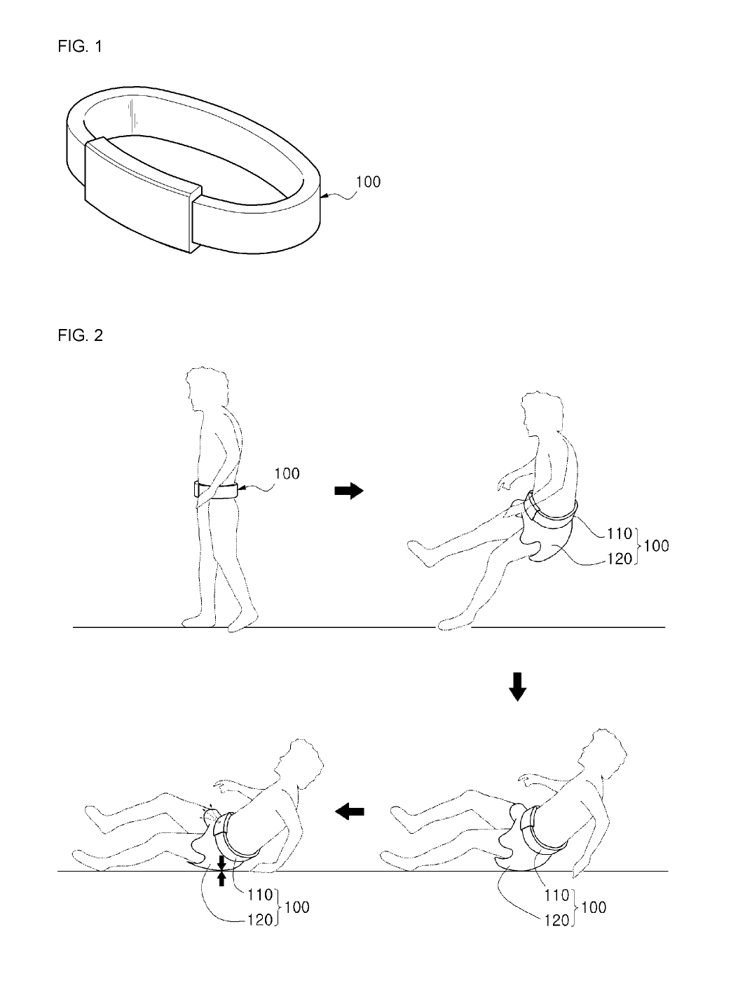

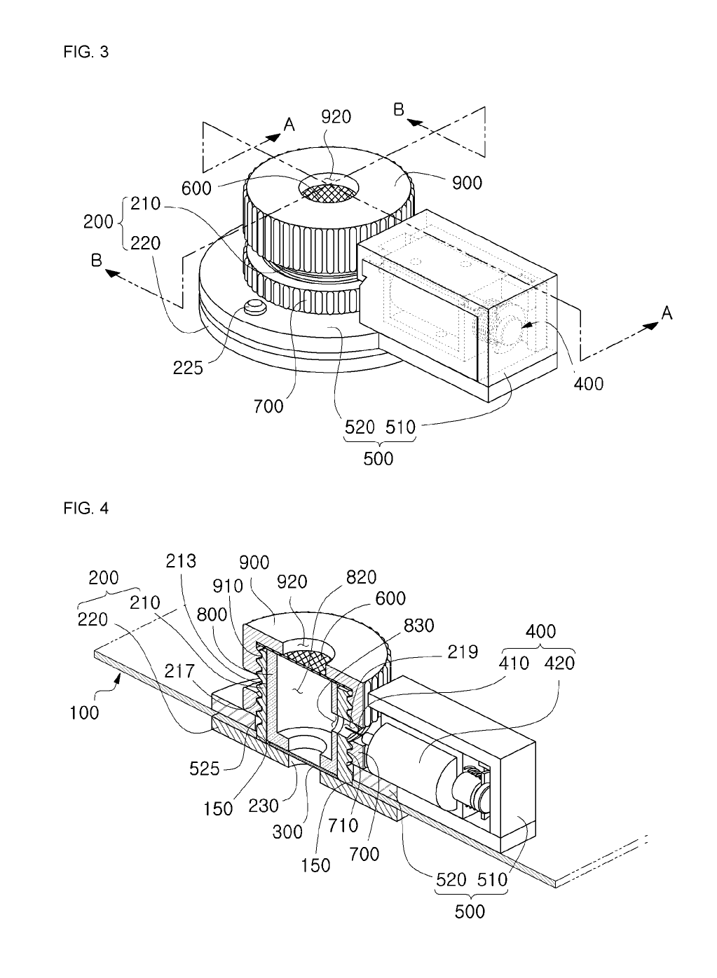

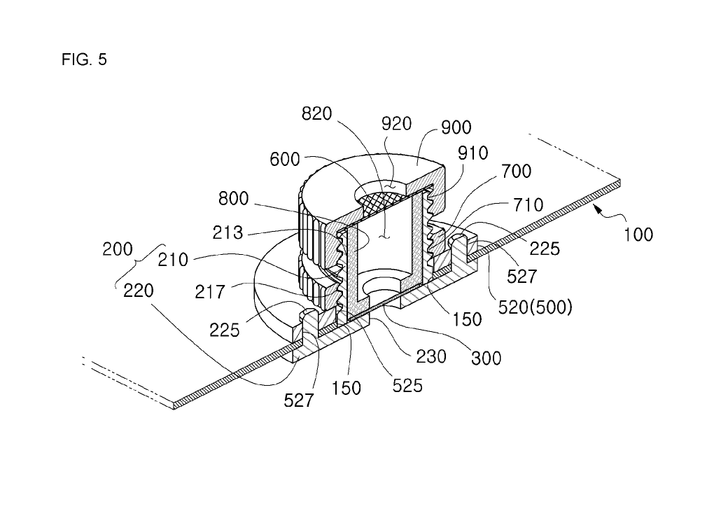

FIG. 1 is a conceptual diagram of an airbag including a vent hole according to an embodiment of the present disclosure, FIG. 2 is an operational conceptual diagram of the airbag including a vent hole according to an embodiment of the present disclosure, FIG. 3 is a perspective view of the airbag including a vent hole according to an embodiment of the present disclosure, FIG. 4 is a cut-away perspective view of the airbag including a vent hole shown in FIG. 3, taken along the line A-A, and FIG. 5 is a cut-away perspective view of the airbag including a vent hole shown in FIG. 3, taken along the line B-B.

As shown in FIGS. 1 to 5, the airbag including a vent hole according to this embodiment includes a protection means 100 which is mounted on a user's predetermined body part, and when gas is injected, expands to protect the user, a body portion 200 which is inserted into a vent hole 150 formed in the protection means 100 to bring the inside and outside of the protection means 100 into fluid communication, an elastic body 300 which closes the body portion 200, and when gas is injected into the protection means 100, expands by the internal gas pressure of the protection means 100, and an opening/closing means 400 which after the user falls, tears the expanded elastic body 300 to open the body portion 200 so as to discharge the gas injected into the protection means 100 to the outside.

The protection means 100 plays a role in protecting the user. Here, the protection means 100 may generally include a case 110 and a protection element 120 (see FIG. 2). In this instance, the case 110 is formed such that it may be mounted on the user's predetermined body part. For example, the case 110 may be formed in the shape of a belt such that it may be mounted on the user's waist. Furthermore, the protection element 120 is received in the case 110, and when the user starts to fall, expands by gas injected therein, so the protection element 120 may substantially protect the user. For example, as shown in FIG. 2, the protection element 120 may be received in the case 110 mounted on the user's waist, and when gas is injected by an inflator, may expand in the shape of a skirt around the user's hip (pelvis and hip joint parts) to protect the user. Meanwhile, the vent hole 150 is formed on one side of the protection means 100 (see FIGS. 4 and 5). The vent hole 150 plays a role in discharging the gas injected into the protection means 100 to the outside. Here, the vent hole 150 may be provided on one side of the protection means 100 to bring the inside and outside of the protection means 100 into communication when the vent hole 150 is opened. In this instance, the location of the vent hole 150 is not particularly limited, but the vent hole 150 may be disposed at the lumbar spine part not hidden by the user's body to avoid the direct shock of the fall and minimize the influence of joint motion. Specifically, the vent hole 150 may be opened immediately or in a predetermined time after the user falls. When the vent hole 150 is opened after the user falls, the gas injected into the protection means 100 may be discharged to the outside. Accordingly, it is possible to reduce the rebound force of the protection means 100 produced by collision with the ground when the user falls, and as a result, prevent secondary injuries of other body parts (body parts other than lumbar spine or pelvis). Meanwhile, the vent hole 150 may be closed and opened by the body portion 200, the elastic body 300 and the opening/closing means 400, and its detailed description will be provided below.

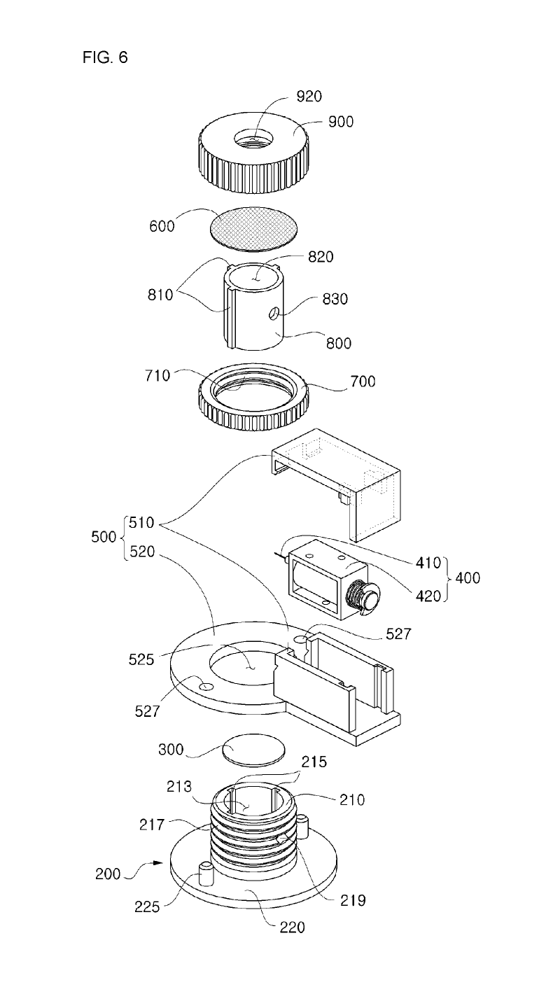

The body portion 200 may be inserted into the vent hole 150 formed in the protection means 100 to bring the inside and outside of the protection means 100 into fluid communication. Here, the body portion 200 may extend in a tubular shape on the whole. Specifically, as shown in FIG. 6, the body portion 200 may include a body 210 formed in a tubular shape, and a flat plate portion 220 which extends in the radial direction from one end of the body 210 and contacts the inner side of the protection means 100. In this instance, the body 210 has a first through-hole 213 in the lengthwise direction to bring the inside and outside of the protection means 100 into fluid communication when the elastic body 300 is torn off. 6p The elastic body 300 plays a role in substantially closing the vent hole 150 (the first through-hole 213 of the body portion 200) (see FIGS. 4 and 5). Here, the elastic body 300 closes the first through-hole 213 of the body portion 200, and when gas is injected into the protection means 100, expands by the internal gas pressure of the protection means 100. Specifically, the elastic body 300 may be provided at one end of the body portion 200 (the body 210), and when gas is injected into the protection means 100, may expand toward the other end of the body portion 200 (the body 210) from the inside of the body portion 200 (the body 210) by the internal gas pressure of the protection means 100. More specifically, the elastic body 300 may be provided within one end of the first through-hole 213 of the body 210, and as the internal gas pressure of the protection means 100 increases, may expand toward the other end of the first through-hole 213 of the body 210 along the first through-hole 213 of the body 210 by the gas pressure. In this instance, the elastic body 300 is not limited to a particular type if it is so elastic that it can expand by the internal gas pressure of the protection means 100, but for example, may be formed of a rubber plate.

Additionally, if the elastic body 300 keeps expanding, the elastic body 300 may be unintentionally torn off, and a confining means 600 may be provided to confine the expansion of the elastic body 300. Here, the confining means 600 may be provided at the other end of the body portion 200 (the body 210) to confine the expansion of the elastic body 300 within the first through-hole 213 of the body 210. However, the confining means 600 confines the expansion of the elastic body 300, while discharging the gas injected into the protection means 100. As described above, to discharge the gas injected into the protection means 100 with confining the expansion of the elastic body 300, the confining means 600 may be a mesh net.

Meanwhile, to support the elastic body 300, the body portion 200 may further include a support protrusion 230. Here, the support protrusion 230 protrudes out from one end of the first through-hole 213 of the body 210. Accordingly, the support protrusion 230 may support the elastic body 300 while contacting one surface of the elastic body 300. Furthermore, a fixing body 800 may be provided to fix the elastic body 300 supported on the support protrusion 230. Here, the fixing body 800 is formed in a tubular shape, and is inserted into the first through-hole 213 of the body 210 such that one end contacts the other surface of the elastic body 300 (an opposite surface to one surface that contacts the support protrusion 230). In this instance, the fixing body 800 has a second through-hole 820 in the lengthwise direction, and when the elastic body 300 is torn off, the gas injected into the protection means 100 may be discharged to the outside through the second through-hole 820. Furthermore, the elastic body 300 may be guided by the second through-hole 820 of the fixing body 800, and expand from one end of the fixing body 800 toward the other end. Meanwhile, as shown in FIG. 6, a guide protrusion 810 extending in the lengthwise direction of the fixing body 800 may be formed on the outer peripheral surface of the fixing body 800, and a guide groove 215 extending in the lengthwise direction of the body 210 may be formed on the inner peripheral surface of the body 210 (the sidewall of the first through-hole 213) such that the guide groove 215 matches the guide protrusion 810. Accordingly, as the guide protrusion 810 slides along the guide groove 215, the fixing body 800 may be inserted into the body 210 (the first through-hole 213). In this instance, the coupling of the guide protrusion 810 and the guide groove 215 may prevent the fixing body 800 from rotating around the body 210. Additionally, as shown in FIGS. 4 and 5, the other end(an opposite end to one end that contacts the elastic body 300) of the fixing body 800 is configured to be contacted with a cover 900 and fixed thereto, the cover 900 being coupled to the body 210. That is, the fixing body 800 is pressed and fixed by the cover 900. Accordingly, as one surface of the elastic body 300 is supported by the support protrusion 230 and the other surface is pressed by the fixing body 800, the elastic body 300 completely closes the first through-hole 213 of the body portion 200. Furthermore, the confining means 600 is placed between the fixing body 800 and the cover 900 with both surfaces each pressed by the fixing body 800 and the cover 900, so that the confining means 600 may be stably fixed. Meanwhile, the body 210 and the cover 900 may be screw-coupled together. Specifically, a first screw thread 217 may be formed on the outer peripheral surface of the body 210, a second screw thread 910 may be formed on the inner peripheral surface of the cover 900, and the first screw thread 217 of the body 210 and the second screw thread 910 of the cover 900 may be screw-coupled together. Furthermore, the cover 900 has a third through-hole 920 at the center, and when the elastic body 300 is torn off, the gas injected into the protection means 100 may be discharged to the outside through the third through-hole 920. As described above, the elastic body 300 is pressed and fixed by the fixing body 800 and the cover 900. Accordingly, it is possible to simply replace the elastic body 300 by separating the fixing body 800 and the cover 900 from the body 210 after the gas injected into the protection means 100 is discharged to the outside by the tear of the elastic body 300.

The opening/closing means 400 plays a role in substantially controlling the opening of the vent hole 150 (the first through-hole 213 of the body portion 200). Here, after the user falls, the opening/closing means 400 tears the expanded elastic body 300 to open the body portion 200 (the first through-hole 213) so as to discharge the gas injected into the protection means 100 to the outside. In this instance, the opening/closing means 400 may tear the elastic body 300 between one end and the other end of the body portion 200 (the body 210). That is, the opening/closing means 400 is placed in the middle in the lengthwise direction of the body portion 200 (the body 210) (between one end and the other end of the body 210), and before expansion, the elastic body 300 is placed at one end of the body portion 200. Accordingly, before the elastic body 300 expands, the opening/closing means 400 and the elastic body 300 are placed on different planes, and there is no risk that the elastic body 300 will be torn by the opening/closing means 400. However, when the elastic body 300 expands, the opening/closing means 400 and the elastic body 300 overlap on the same plane, and the elastic body 300 may be torn by the opening/closing means 400.

Specifically, the opening/closing means 400 may include a needle portion 410 having a sharp tip, and a movement means 420 to move the needle portion 410 toward the expanded elastic body 300. That is, the needle portion 410 may be spaced apart from the elastic body 300, and when the elastic body 300 expands by the internal gas pressure of the protection means 100, may move toward the elastic body 300 by the movement means 420 and tear the elastic body 300. As described above, when the needle portion 410 of the opening/closing means 400 tears the elastic body 300, the body portion 200 (the first through-hole 213) may be opened at an accurate time, and accordingly the gas injected into the protection means 100 may be discharged to the outside. That is, after the user falls, the elastic body 300 is torn by the opening/closing means 400, thereby reducing the rebound force of the protection means 100 produced by collision with the ground when the user falls, and as a result, preventing secondary injuries other body parts (body parts other than lumbar spine or pelvis). Meanwhile, the movement means 420 is not limited to a particular type if it can move the needle portion 410, but for example, may be formed of a solenoid actuator.

Meanwhile, a support 500 may be provided to support the opening/closing means 400. Here, the support 500 may include a support housing 510 and a support plate 520. Specifically, as shown in FIG. 6, the support housing 510 may be formed in the shape of a box in which the opening/closing means 400 is received to support the opening/closing means 400. Furthermore, the support plate 520 may extend in an annular shape from the support housing 510, have, at a center thereof, an insertion hole 525 into which the body 210 of the body portion 200 is inserted, and contact the outer side of the protection means 100, facing the flat plate portion 220 of the body portion 200 (see FIGS. 4 and 5). In this instance, as shown in FIG. 5, the flat plate portion 220 may have a coupling protrusion 225 that protrudes toward the support plate 520, and the support plate 520 may have a coupling hole 527 that matches the coupling protrusion 225. Accordingly, when the flat plate portion 220 and the support plate 520 face each other with the protection means 100 interposed between, the coupling protrusion 225 of the flat plate portion 220 may be inserted into the coupling hole 527 of the support plate 520. Additionally, the support plate 520 of the support 500 may be fixed in contact with a coupling means 700 coupled to the body 210. Accordingly, one surface of the support plate 520 of the support 500 is supported by the flat plate portion 220, and the other surface is pressed by the coupling means 700. As described above, when the coupling protrusion 225 of the flat plate portion 220 is inserted into the coupling hole 527 of the support plate 520, the support plate 520 is pressed by the coupling means 700, and thus the support plate 520 and the flat plate portion 220 may be stably coupled to each other. Meanwhile, the body 210 and the coupling means 700 may be screw-coupled together. Specifically, the first screw thread 217 may be formed on the outer peripheral surface of the body 210, a third screw thread 710 may be formed on the inner peripheral surface of the coupling means 700, and the first screw thread 217 of the body 210 and the third screw thread 710 of the coupling means 700 may be screw-coupled together.

Additionally, as shown in FIG. 4, for the needle portion 410 of the opening/closing means 400 to move toward the expanded elastic body 300, a first movement hole 219 may be formed between one end and the other end of the body 210 (in the middle in the lengthwise direction of the body 210). Furthermore, a second movement hole 830 may be formed between one end and the other end of the fixing body 800 (in the middle in the lengthwise direction of the fixing body 800) such that the second movement hole 830 matches the first movement hole 219 formed in the body 210. Accordingly, the needle portion 410 of the opening/closing means 400 may tear the expanded elastic body 300 straight through the first movement hole 219 of the body 210 and the second movement hole 830 of the fixing body 800.

### MODE FOR INVENTION

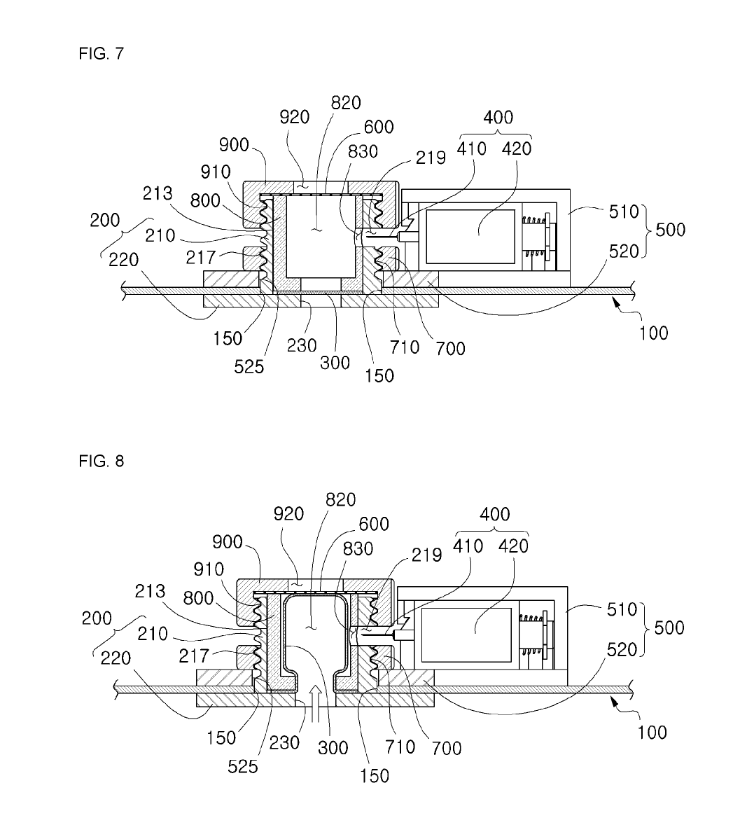

FIGS. 7 to 10 are cross-sectional views showing the operation process of the airbag including a vent hole according to an embodiment of the present disclosure, and the operation process of the airbag including a vent hole according to this embodiment will be described with reference to FIGS. 7 to 10.

First, as shown in FIG. 7, before the user falls, gas is not injected into the protection means 100. Accordingly, the elastic body 300 does not expand by the internal gas pressure of the protection means 100, and keeps flat.

Subsequently, as shown in FIG. 8, when the user starts to fall, gas is injected into the protection means 100 which then expands, and the elastic body 300 expands by the internal gas pressure of the protection means 100. In this instance, the elastic body 300 may expand from one end of the body 210 toward the other end along the first through-hole 213 of the body 210, and may be guided by the second through-hole 820 of the fixing body 800. However, the fixing body 800 does not continue to expand from one end of the body 210 toward the other end, and the expansion is confined within the first through-hole 213 of the body 210 by the confining means 600 provided at the other end of the body 210.

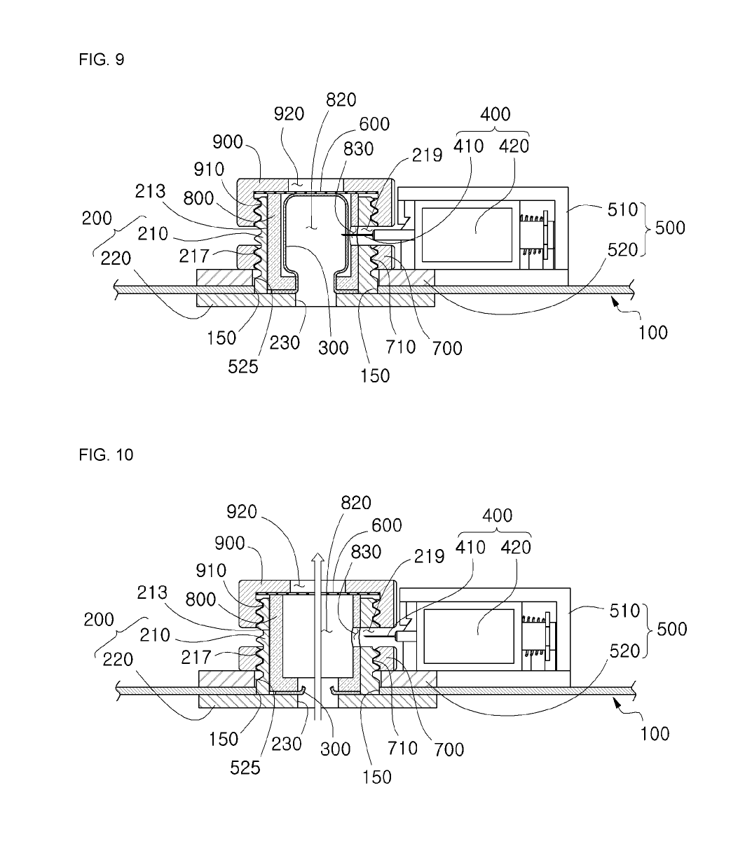

Subsequently, as shown in FIGS. 9 and 10, after the user falls, the needle portion 410 of the opening/closing means 400 is moved toward the expanded elastic body 300 by the movement means 420. In this instance, the needle portion 410 tears through the elastic body 300 to discharge the gas injected into the protection means 100 to the outside. That is, when the elastic body 300 is torn off, the gas injected into the protection means 100 will be discharged to the outside through the first through-hole 213 of the body 210, the second through-hole 820 of the fixing body 800, and the third through-hole 920 of the cover 900 (see FIG. 10). As described above, after the user falls, the gas injected into the protection means 100 is discharged to the outside, thereby reducing the rebound force of the protection means 100 produced by collision with the ground when the user falls, and as a result, preventing secondary injuries of other body parts (body parts other than lumbar spine or pelvis). Particularly, as the elastic body 300 is torn using the opening/closing means 400, the gas injected into the protection means 100 may be discharged at an accurate time.

While the present disclosure has been hereinabove described in detail through specific embodiments, this is provided to particularly describe the present disclosure, and the present disclosure is not limited thereto, and it is obvious to those skilled in the art that modification or change may be made thereto within the technical spirit of the present disclosure.

Such modification or change of the present disclosure falls in the scope of the present disclosure and specific protection scope of the present disclosure will be clearly defined by the appended claims.

### DETAILED DESCRIPTION OF MAIN ELEMENTS

100: Protection means 110: Case

120: Protection element 150: Vent hole

200: Body portion 210: Body

213: First through-hole 215: Guide groove

217: First screw thread 219: First movement hole

220: Flat plate portion 225: Coupling protrusion

230: Support protrusion 300: Elastic body

400: Opening/closing means 410: Needle portion

420: Movement means 500: Support

510: Support housing 520: Support plate

525: Insertion hole 527: Coupling hole

600: Confining means 700: Coupling means

710: Third screw thread 800: Fixing body

810: Guide protrusion 820: Second through-hole

830: Second movement hole 900: Cover

910: Second screw thread 920: Third through-hole

### INDUSTRIAL APPLICABILITY

The present disclosure relates to an airbag including a vent hole, in which the vent hole for discharging gas injected into protection means to the outside is controlled to prevent secondary injuries of other body parts caused by the rebound force of the protection means.

1. An airbag including a vent hole, comprising:
A protection means which is mounted on a predetermined body part of a user, and expands to protect the user when gas is injected;
A body portion which is inserted into a vent hole formed in the protection means to bring inside and outside of the protection means into fluid communication;
An elastic body which closes the body portion, and expands by internal gas pressure of the protection means when the gas is injected into the protection means; and
An opening/closing means which after the user falls, tears the expanded elastic body to open the body portion so as to discharge the gas injected into the protection means to outside.

2. The airbag including a vent hole according to claim 1, wherein the body portion extends in a tubular shape,
The elastic body is provided within one end of the body portion, and expands toward the other end of the body portion by the internal gas pressure of the protection means when the gas is injected into the protection means, and
The airbag including a vent hole further comprises a confining means which is provided at the other end of the body portion to confine the expansion of the elastic body while discharging the gas injected into the protection means.

3. The airbag including a vent hole according to claim 2, wherein the opening/closing means tears the elastic body between one end and the other end of the body portion.

4. The airbag including a vent hole according to claim 1, wherein the body portion comprises:
A body formed in a tubular shape; and
A flat plate portion which extends in a radial direction from one end of the body and contacts an inner side of the protection means.

5. The airbag including a vent hole according to claim 4, wherein the elastic body is provided within one end of the body, and expands toward the other end of the body by the internal gas pressure of the protection means when the gas is injected into the protection means, and
The airbag including a vent hole further comprises a confining means which is provided at the other end of the body to confine the expansion of the elastic body while discharging the gas injected into the protection means.

6. The airbag including a vent hole according to claim 5, wherein the body portion further comprises a support protrusion which protrudes out from one end of the body, and contacts one surface of the elastic body.

7. The airbag including a vent hole according to claim 6, further comprising:
A fixing body which is formed in a tubular shape, and is inserted into the body such that one end contacts the other surface of the elastic body.

8. The airbag including a vent hole according to claim 7, wherein a guide protrusion extending in a lengthwise direction of the fixing body is formed on an outer peripheral surface of the fixing body, and
A guide groove extending in a lengthwise direction of the body is formed on an inner peripheral surface of the body such that the guide groove matches the guide protrusion.

9. The airbag including a vent hole according to claim 7, wherein the other end of the fixing body is configured to be contacted with a cover and fixed thereto, the cover being coupled to the body.

10. The airbag including a vent hole according to claim 9, wherein the confining means is placed between the fixing body and the cover.

11. The airbag including a vent hole according to claim 9, wherein a first screw thread is formed on an outer peripheral surface of the body, a second screw thread is formed on an inner peripheral surface of the cover, and the first screw thread and the second screw thread are screw-coupled together.

12. The airbag including a vent hole according to claim 2, wherein the confining means is a mesh net.

13. The airbag including a vent hole according to claim 1, wherein the opening/closing means comprises:
A needle portion having a sharp tip; and
A movement means which moves the needle portion toward the expanded elastic body.

14. The airbag including a vent hole according to claim 13, wherein the movement means is a solenoid actuator.

15. The airbag including a vent hole according to claim 4, further comprising:
A support,
Wherein the support comprises:
A support housing which supports the opening/closing means; and
A support plate which extends from the support housing, has, at a center thereof, an insertion hole into which the body is inserted, and contacts an outer side of the protection means, facing the flat plate portion.

16. The airbag including a vent hole according to claim 15, wherein the flat plate portion has a coupling protrusion which protrudes toward the support plate,
The support plate has a coupling hole which matches the coupling protrusion, and
The coupling protrusion is inserted into the coupling hole.

17. The airbag including a vent hole according to claim 15, wherein the support plate is fixed in contact with a coupling means coupled to the body.

18. The airbag including a vent hole according to claim 17, wherein a first screw thread is formed on an outer peripheral surface of the body, a third screw thread is formed on an inner peripheral surface of the coupling means, and the first screw thread and the third screw thread are screw-coupled together.

19. The airbag including a vent hole according to claim 5, wherein the confining means is a mesh net.
